(19) United States
(12) Patent Application Publication
(10) Pub. No.: US 2016/0339517 A1
(43) Pub. Date: Nov. 24, 2016

(54) POWDERS FOR ADDITIVE MANUFACTURING

(71) Applicant: Applied Materials, Inc., Santa Clara, CA (US)

(72) Inventors: Ajey M. Joshi, San Jose, CA (US); Ashavani Kumar, Sunnyvale, CA (US); Kasiraman Krishnan, Milpitas, CA (US); Nag B. Patibandla, Pleasanton, CA (US); Ranga Rao Arnepalli, Bapulapadu (IN); Prerna Goradia, Mumbai (IN)

(73) Assignee: Applied Materials, Inc., Santa Clara, CA (US)

(21) Appl. No.: 14/811,228

(22) Filed: Jul. 28, 2015

Related U.S. Application Data
(60) Provisional application No. 62/165,118, filed on May 21, 2015.

(51) Int. Cl. B22F 1/00; B22F 3/105; B22F 1/02

(52) U.S. Cl. CPC B22F 1/0007; B22F 1/025; B22F 3/1055; B22F 1/0011; B33Y 10/00

(57) ABSTRACT

A precursor for additive manufacturing includes a powder of metallic particulates, each particulate having a metal core having mean diameters between 10 and 150 μm, the metal core having a first melting temperature; and each of the metal core having a functionalized surface, the functionalized surface includes a metallic material having a second melting point lower than the first melting point.

### CROSS-REFERENCE TO RELATED APPLICATIONS

This application claims priority to U.S. Application Ser. No. 62/165,118, filed on May 21, 2015, the entirety of which is incorporated by reference.

### TECHNICAL FIELD

The present invention relates generally to additive manufacturing, also referred to as 3D printing.

### BACKGROUND

Additive manufacturing (AM), also known as solid freeform fabrication or 3D printing, refers to any manufacturing process where three-dimensional objects are built up from raw material (generally powders, liquids, suspensions, or molten solids) in a series of two-dimensional layers or cross-sections. In contrast, traditional machining techniques involve subtractive processes and produce objects that are cut out of a stock material such as a block of wood or metal.

A variety of additive processes can be used in additive manufacturing. The various processes differ in the way layers are deposited to create the finished objects and in the materials that are compatible for use in each process. Some methods melt or soften material to produce layers, e.g., selective laser melting (SLM) or direct metal laser sintering (DMLS), selective laser sintering (SLS), fused deposition modeling (FDM), while others cure liquid materials using different technologies, e.g., stereolithography (SLA).

Sintering is a process of fusing small grains, e.g., powders, to create objects. Sintering usually involves heating a powder. When a powdered material is heated to a sufficient temperature in a sintering process, the atoms in the powder particles diffuse across the boundaries of the particles, fusing the particles together to form a solid piece. In contrast to melting, the powder used in sintering need not reach a liquid phase As the sintering temperature does not have to reach the melting point of the material, sintering is often used for materials with high melting points such as tungsten and molybdenum.

Both sintering and melting can be used in additive manufacturing. Selective laser melting (SLM) is used for additive manufacturing of metals or metal alloys (e.g. titanium, gold, steel, Inconel, cobalt chrome, etc.), which have a discrete melting temperature and undergo melting during the SLM process.

### SUMMARY

In one aspect, a precursor for additive manufacturing, the precursor includes a powder of metallic particulates, each particulate having a metal core and a functionalized surface, the metal core having a dimension a mean diameter between 200 nm- and 150 μm and having a first melting temperature. The functionalized surface including a metallic material having a second melting point lower than the first melting point.

Implementations can include one or more of the following features. The functionalized surface can include a plurality of metallic nanoparticles having dimensions 3-100 nm anchored on the metal core. A metal in the plurality of metallic nanoparticles can be the metal in the metal core. The metal in the metal core can include only copper. The metal in the plurality of metallic nanoparticles can include only copper. The second melting point can be lower than the first melting point. The second melting point of the nanoparticles can be at least 100° C. lower than the first melting point of the metal core. The functionalized surface can include a metallic shell surrounding the metal core. The metal core can include one or more of refractory metals, transition metals and/ or noble metals. The metallic material can include one or more of copper, titanium, tungsten, and molybdenum.

In another aspect, a method of synthesizing a metallic powder precursor for additive manufacturing, the method includes mixing a powder of metallic microparticles with metallic nanoparticles, each metal microparticle including a metal core having a dimension between 10 and 150 μm. The metallic nanoparticles can have a second melting temperature lower than a first melting temperature of the metal cores. The method includes anchoring a plurality of metallic nanoparticles on the metal core of each microparticle.

Implementations can include one or more of the following features. The metallic nanoparticles can be anchored onto the metal cores by a coordinating agent. The coordinating agent can include at least two functional groups, one functional group forming a bond between the metal core and the coordinating agent, and at least one other functional group forming a bond between the metallic nanoparticles and the coordinating agent. The coordinating agent can include a diamine, di carboxylic acid, a dithiol, an amino thiol, aminocarboxylic or a carboxy thiol.

In another aspect, a method of synthesizing metallic powder precursor for additive manufacturing, the method includes providing a powder of metallic microparticles, each microparticle including a metal core that has a first melting temperature and a dimension between 10 and 150 μm, The method includes depositing a second metallic material having a second melting temperature lower than the first melting temperature on the metal core of each microparticle by chemical vapor deposition.

Implementations can include one or more of the following features. Nanoparticles of the second metallic material can be deposited on each metal core. Islands of the second metallic material can be deposited on each metal core. A shell of the second metallic material can be deposited on each metal core. The metal core can include one or more of tungsten, molybdenum, aluminum, bismuth, and copper, tantalum, chromium and the shell comprises one or more of nickel, cobalt, silicon, silver, bismuth and tellurium.

In another aspect, a method additive manufacturing, the method includes depositing on a platen a metallic powder precursor that includes a powder of metallic particulates, each particulate having a metal core and a functionalized surface, the metal core having a dimension mean diameter between 10 and 150 μm, the metal core having a first melting temperature. The functionalized surface can include a metallic material having a second melting point lower than the first melting point. The method includes fusing the metallic powder precursor on the platen so that the functionalized surface melts, binds and consolidates the metallic powder precursor to form a sintered additive manufactured part.

Implementations can include one or more of the following features. A rate of sintering of the metallic powder precursor can be higher than a rate of sintering the metal core. Sintering can include exposing the metallic powder precursor to a laser or electron beam bombardment. The metal core can include one or more of tungsten, molybdenum, aluminum, bismuth, and copper, and the functionalized surface comprises one or more of nickel, cobalt, silicon, silver and tellurium.

Advantages may include optionally one or more of the following. A lower amount of energy is used to achieve fusing of a precursor material to form a sintered part. A larger number of sintered parts can be formed (i.e., a higher throughput can be achieved) when a constant amount of energy is provided per unit time. Lower processing temperature for sintering the parts can also result in lower thermal stress in the material. Lower processing temperatures also means that low thermal budget and low cost of ownership. The techniques and methods disclosed herein can allow other metal which have not been printed so far be used in additive manufacturing.

### BRIEF DESCRIPTION OF DRAWINGS

FIG. 1A is a schematic view of a particle having a functionalized surface.

FIG. 1B illustrates a method of obtaining the particle of FIG. 1A.

FIG. 1C is a Transmission electron microscope (TEM) image of copper core particles.

FIG. 1D is a TEM image of copper nanoparticles.

FIG. 1E is a TEM image of a copper core particle having copper nanoparticles anchored thereon.

FIG. 1F is high magnification of FIG. 1E

FIG. 1G is a schematic diagram showing the coordinating agent between the core particle and the nanoparticle with change in the length of the aliphatic chain.

FIG. 1H is Scanning Electron Microscopy (SEM) image of Cu core particles.

FIG. 1I is SEM image of nanoparticles on core particles.

FIG. 1J shows differential scanning calorimetry (DSC) data of copper nanoparticles and copper core with nanoparticles

FIG. 2A shows a TEM image of commercial titanium core particles.

FIG. 2B shows a TEM image of titanium nanoparticles.

FIG. 2C shows a TEM image of titanium nanoparticles on titanium core particles.

FIG. 2D illustrates methods for synthesizing titanium nanoparticles.

FIG. 3A is a schematic diagram of a core-shell particle.

FIG. 3B illustrates methods for synthesizing core-shell particles shown in FIG. 3A.

FIG. 3C is a TEM image of a core-shell particle.

FIG. 3D is a TEM image of a core-shell particle.

FIG. 3E is a TEM image of a core-shell particle.

FIG. 4A is a TEM image of an un-modified core particle.

FIG. 4B shows a schematic diagram of an electroplating setup.

FIG. 4C is a TEM image of an electroplated copper particle.

FIG. 4D is a TEM image of an electroplated copper particle.

FIG. 4E is a TEM image of an electroplated particle after surface modification.

FIG. 4F is a TEM image of an electroplated particle after surface modification.

### DETAILED DESCRIPTION

In 3D manufacturing of metal objects, such as by selective laser melting (SLM), metals and metal alloys have a melting temperature that is sufficiently high to require significant energy from a laser source. This makes the SLM process relatively slow. Other challenges include thermal stress due to high temperature gradients in the object being fabricated, which can lead to defects in the object. Refractive metals, which have even higher melting temperature among the metals, impose additional challenges. However, these challenges can be overcome by designing new metal powder that exploit nanoscale properties of metals.

By functionalizing bigger core particles with smaller nanoparticles or thin coating, the effective sintering and ultimate melting point of the powder is reduced. Without being limited to any particular theory, this is because the nanoparticles coating on the bulk powder sinters and melts at lower temperature compared to the bulk powder. Reduction in the melting point of the nanoparticles compared to their bulk particle is a phenomena and physical property of the material. As the physical size of the material decreases to nanoscale the depression in melting point/decrease in melting point occurs. Nanosize materials can melt at temperatures hundreds of degrees lower than that of their equivalent bulk materials. Changes in melting point occur because nanoscale materials have a much larger surface energy due to high surface -to-volume ratio than bulk materials, drastically altering their thermodynamic and thermal properties. As the metal particle size decreases, the melting temperature also decreases. By having nanoparticles coated on the bulk particles of the powder, the overall sintering/melting point of the powder can be reduced.

This permits a low temperature melting powder of metal particles (e.g. —Cu, W, Ti, Cr, Co, Mo, Ta etc) for additive manufacturing. This can not only permit 3D printing at lower temperature with high throughput, but can also enable the use of other metals which have not been printed by current technology.

Refractory metals parts used in components and systems for critical and/or high temperature applications, such as propulsion systems for aircrafts, missiles and nuclear reactors. can be manufactured using 3D printing. Examples of such refractory metals include tungsten (W), molybdenum (Mo), titanium (Ti), and tantalum (Ta). Particles of such refractory metals can be synthesized in their oxide, nitride, or phosphide forms, (e.g., Ta₂O₅, TaN, TaON, TaO; MoS₂, MoO₃, Mo₂N, Mo₂C, MoP), and methods are being developed to synthesize nanoparticles of refractory metals.

3D printing of refractory metal parts can involve sintering particles of refractory metals and fusing them together to form a solid piece. These metallic particles can be between 10 μm to 150 μm in diameter and have melting temperatures that are similar to the melting temperatures of their bulk metal counterpart. The surfaces of these metallic particles can be functionalized, for example, with a coordinating agent (or capping agent), to incorporate nanoscale metallic materials, which have lower melting temperatures compared to the metallic particles. As a result, a smaller amount of energy can be used to sinter and fuse these metallic particles to form a 3D printed part, compared to the energy that would be needed to sinter and fuse uncoated or unmodified metallic particles.

Without wishing to be bound by any particular theory, nanoscale materials can have melting temperatures that differ from those in their bulk counterparts because nanoscale materials have high surface energy due to larger (e.g., much larger) surface-to-volume ratio, which can drastically alter their thermodynamic and thermal properties. For metallic nanoscale particles (i.e., nanoparticles), as their particle size decreases, the melting temperature can also decrease. Differences in melting temperatures can be particularly striking for nanoscale materials that are around or below 100 nm. The shape of the nanoparticles can also influence their melting temperatures. For example, nanoparticles having a regular tetrahedral shape can have a larger decrease in melting temperatures than nanoparticles having a spherical shape. In general, particle shapes can exert a larger effect on the melting temperatures of smaller particles compared to larger particles.

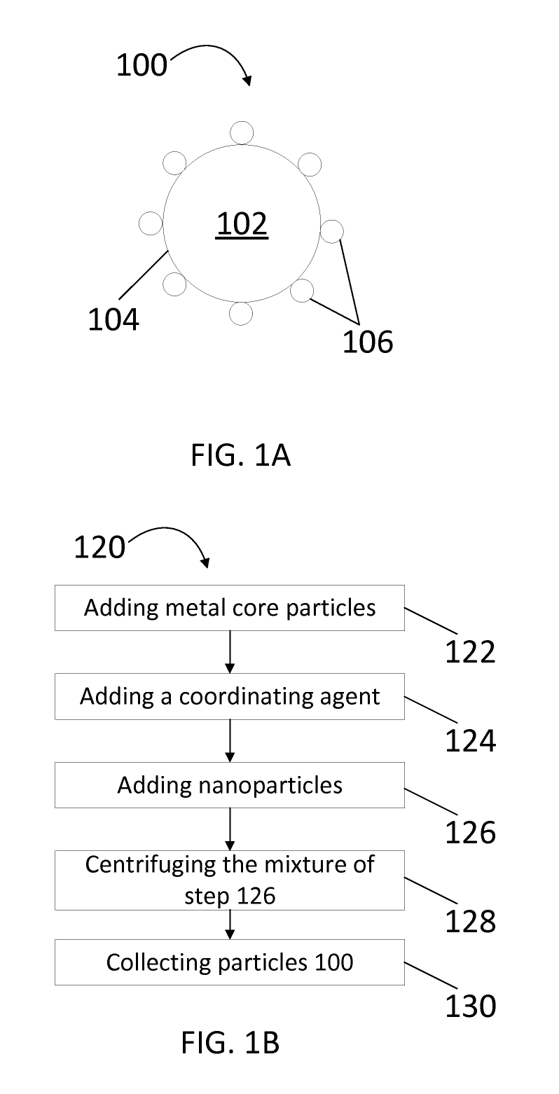

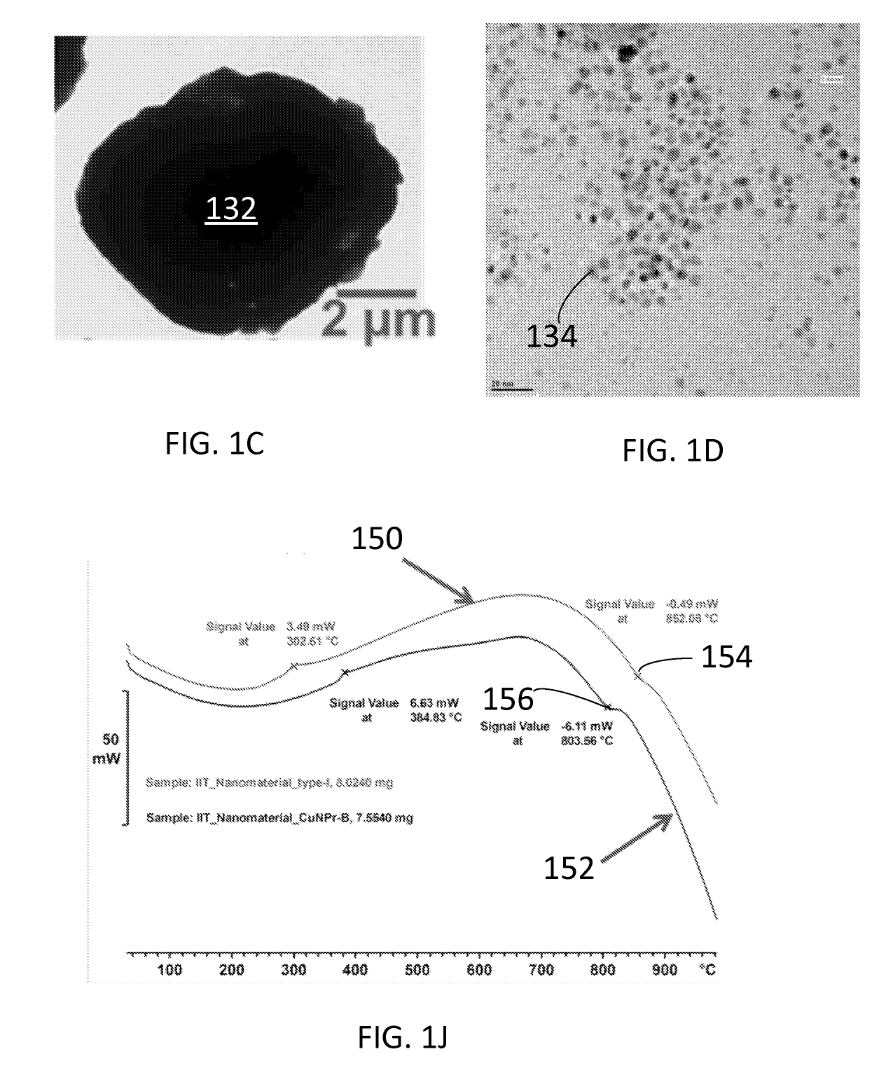

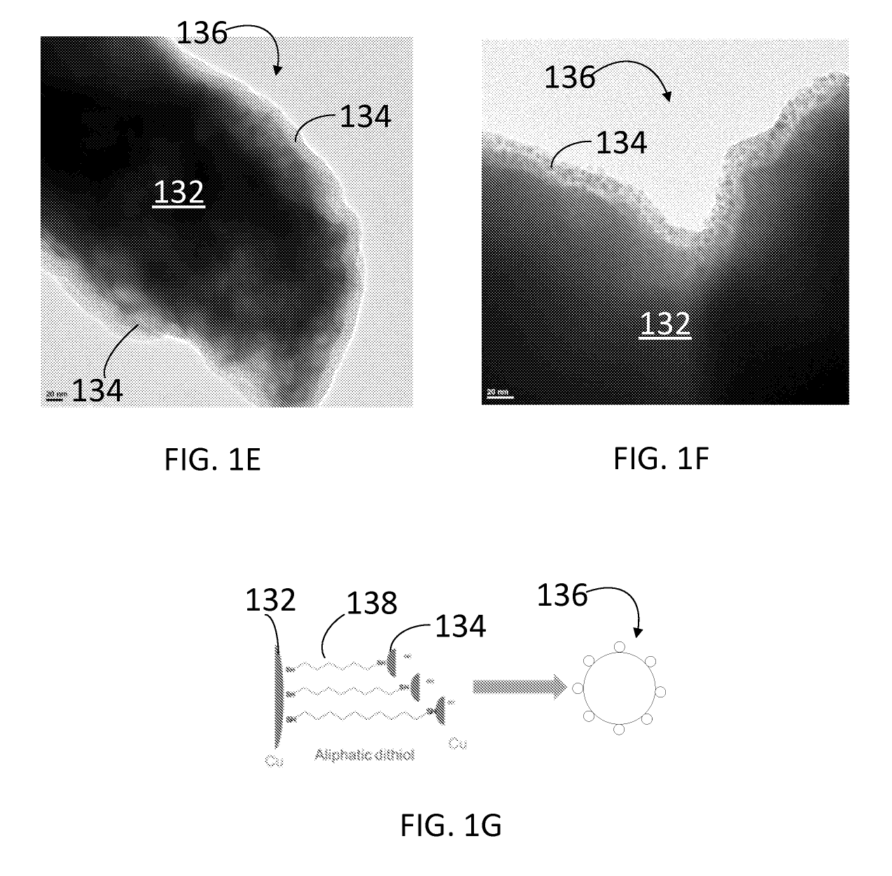

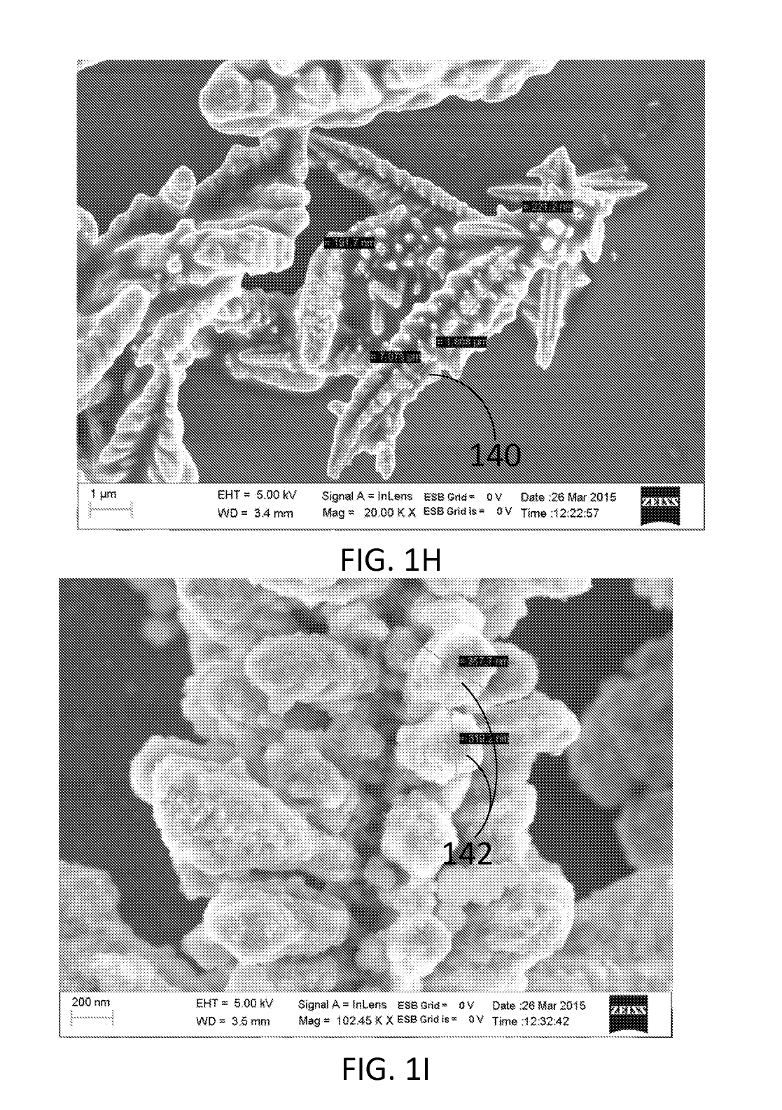

FIG. 1A shows a schematic diagram of a particle 100 having a metallic core 102, and various nanoparticles 106 anchored on the metallic core 102 via a functionalized surface 104. The nanoparticles 106 can be made of the same metal as the metallic core 102. In such a case, the melting temperature of the nanoparticles is lower than that of the bulk metal from which the metallic core 102 is formed. Alternatively, the nanoparticles 106 formed of a different metal from the metallic core 102 can also be used. In such a case, if the bulk metal from which nanoparticles 106 is derived has a lower melting temperature than the metallic core 102, the melting point of the nanoparticles 106 would be further decreased due to their nanoscale dimension and shape.

Examples of metals for the metallic core 120 include tungsten (W), molybdenum (Mo), titanium (Ti), and tantalum (Ta). Examples of metals for the nanoparticles includes these, and also include Au, Ag, Ni, Fe, Cu Cr, Co.

FIG. 1B shows a method 120 of forming the particle 100. In step 122, metal core particles, which can be commercially available, are added to a solvent. For example, commercial copper powder can have variable sizes. In general, sizes and shapes of particles in commercial powders are not controlled, and could range from sub-micron size or about 1 μm to 40 μm. The commercial copper powders are first washed in acetic acid can be added to an ethanol solution and stirred at room temperature. Step 124, which can occur after the mixture obtained from step 122 has been stirred for 1 hour, involves adding a coordinating agent to the mixture. The coordinating agent can be a chemical compound having two or more functional groups—one functional group forming a chemical bond with the metal core 102, and at least another functional group that is free to form chemical bonds with a nanoparticle. The coordinating agent can be a diamine, such a 1,3-diaminopropane, or ethylenediamine, etc. Alternatively, dithols, abd dicarboxylic, such as 4 amino thiophenol, 4 carboxy thiophenols, amino acids, carboxy thiol, aminothiol, and also be used. After stirring the mixture obtained from step 124 for 2-4 hours at room temperature, nanoparticles 106 are added in step 126. The nanoparticles 106 can be, for example, copper nanoparticles. Thereafter in step 128, the mixture from step 126 is centrifuged and the particles 100 can be collected from the mixture in step 130. The collected particles can be dried under vacuum in a vacuum desiccator.

In general, the particles fabricated by these processes can have a core that is about 10-150 μm in diameter and a layer of nanoparticles which have particle dimensions of 3-50 nm.

FIG. 1C shows a TEM image of a commercially available copper core 132 having an average size of 10-50 μm that can be used in step 122. Bulk copper has a melting temperature of 1084° C. while the melting point for copper nanoparticles having a dimension of 3-5 nm is 450° C. FIG. 1D shows copper nanoparticles having sizes between 3-5 nm that can be added in step 126 as shown in FIG. 1B. In other words, the size difference between unit lengths in FIG. 1C and FIG. 1D is in order of 1000 s.

FIG. 1E shows a TEM image of a copper core particle 132 and nanoparticles 134 surrounding the core particle 132. A thin shell of copper nanoparticles can be seen all the surface of core particles. FIG. 1F is a magnified SEM image of FIG. 1E. The nanoparticles 134 completely surround the core particle 132 in this portion of the particle 136.

FIG. 1G shows a schematic diagram of the coordinating agent 138 connecting the right hand side of particle 132 (on the left) with the left hand side of nanoparticle 134 (on the right), to form the particle 136 having a functionalized surface. The exemplary embodiments shown in FIG. 1G use various aliphatic dithiol having different hydrocarbon chain lengths. One thiol group of the aliphatic dithiol forms a Cu—S bond with the core particle 132, and the other thiol group of the aliphatic dithiol forms a second Cu—S bond with the nanoparticle 134. Besides aliphatic dithiol, aromatic dithiol such as benzene-1,4-dithiol can also be used.

FIG. 1H shows a SEM image of uncoated copper core particles. A particle 140 has an elongated profile. Its length is about 7 μm and its width is about 1.8 μm. FIG. 1I is a SEM image of copper core particles with copper nanoparticles anchored thereon. The spherical copper nanoparticles 142 have dimensions between 300-360 nm, indicating the agglomeration of nanoparticles on copper core surface.

FIG. 1J shows DSC data 150 for copper core particles having a functionalized surface onto which copper nanoparticles are attached and DSC data 152 for copper nanoparticles. Dips 154 and 156 at around 850° C. demonstrate the lowering of the melting temperature from a bulk copper melting temperature of 1080° C.

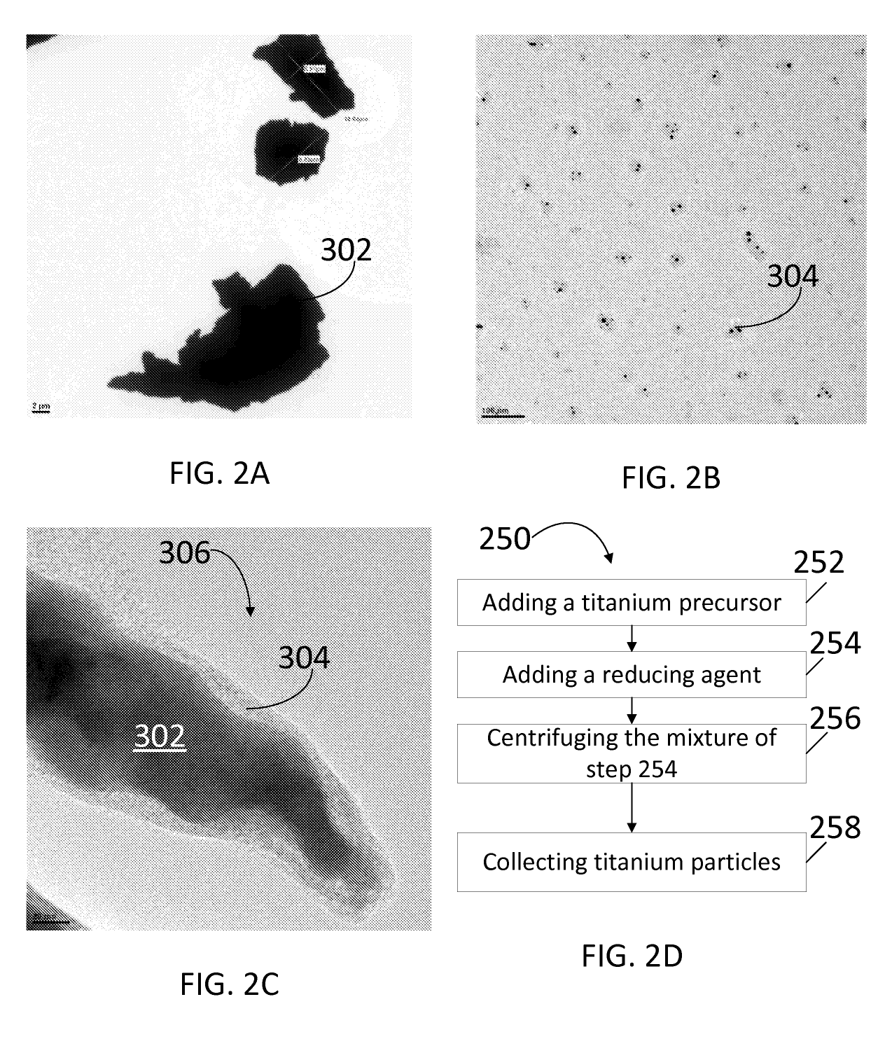

In addition to using copper core particles, titanium core particles can also be used. FIG. 2A shows a TEM image of commercially available Ti core particles having an average size of 1-50 μm. FIG. 2B shows a SEM image of Ti nanoparticles having diameters that is less than 5 nm in a solvent tetrahydrofuran (THF). FIG. 2C shows a region of the particle 306 having a functionalized surface that is coated by Ti nanoparticles 304 showing uniform coverage of the nanoparticle 304. The particles 306 are synthesized using the method described in FIG. 1B, where commercially available Ti particles are added in step 122 and Ti nanoparticles are added in step 126. The coordinating agent used in step 124 in this case is 1,3-diamino-propane.

FIG. 2D shows a method of forming Ti nanoparticles. A Ti precursor, such as titanium halide, TiCl₄, is first added into a solvent THF, and stirred before the reducing agent NaBH₄ is added, and stirred at room temperature to yield the Ti nanoparticles. In general, a metal halide (MXV where X=halogen, v=1, 2, or 3) can be reduced using a nitrogen based reducing agent to form the reduced metal nanoparticle. The process can be carried out using other reducing agent such as LiAlH₄, sodium triethyl borohydride, a tetra-substituted ammonium salt (which is actually a milder reducing agent compared to NaBH₄), or others. A base need not be used in this case. Alternatively, titanium nanoparticles can also be formed by reducing titanium isopropoxide using sodium borohydride (NaBH₄) in the presence of ionic liquids. For example, ionic liquids having as cations n-butyl-tri-methyl-imidazolium, or n-butyl-methyl-imdiazolium, and anions of BF₄, OSO₂CF₃, NO₂SCF₃₂, are some examples of suitable ionic liquids. The synthesis process to obtain phase pure Ti particles should reduce (e.g., avoid) formation of any traces of Ti oxide.

Beside copper and titanium, tungsten can also be used to coat core tungsten (W) particles. For example, tungsten nanoparticles can be formed by decomposing tungsten haxacarbonyl using oleic acid and tri-n-octylphosphine oxide (TOPO) as surfactants. For example, at a reaction temperature of ˜160° C. and over a reaction time of 1-3 hours. The properties of the particles having a functionalized surface on which the W nanoparticles are anchored can be optimized by controlling the particle size, shape and size distribution of these W nanoparticles.

Tantalum nanoparticles can also be synthesized using tantalum carbonyls. For example, metal nanoparticles of chromium, molybdenum, and tungsten can be formed by introducing the respective metal carbonyls to an ionic liquid, and then either heating the mixture at temperatures between 90-230° C. for 6-12 hours, by UV irradiation for about 15 minutes. Metal nanoparticles can be stabilized by the ionic charge, high polarity, high dielectric constant and supramolecular network of ionic liquids, which also provide an electrostatic protection in the form of a protective shell for metal nanoparticles, so that no extra stabilizing molecules are needed.

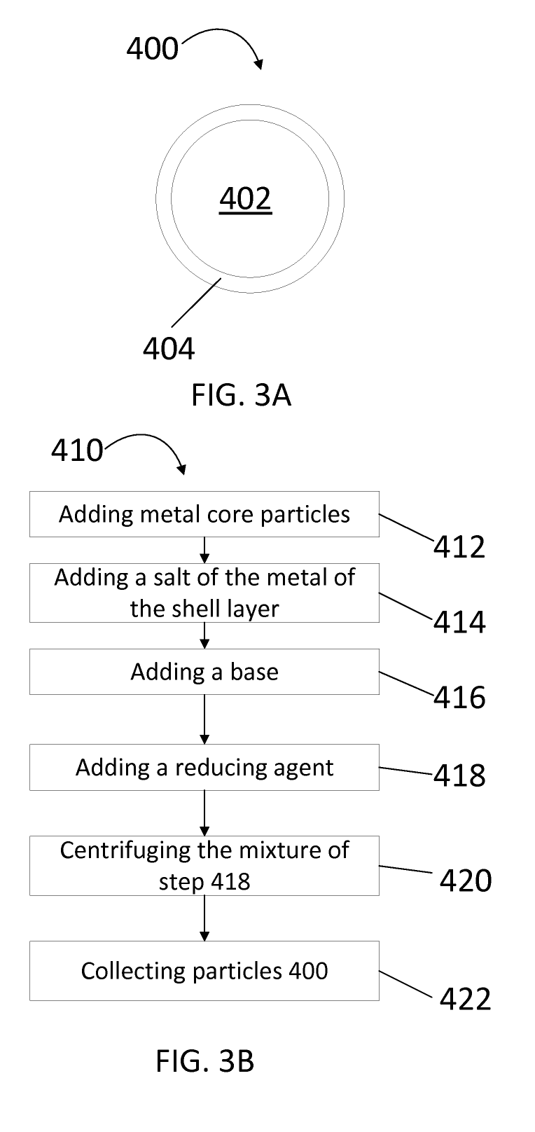

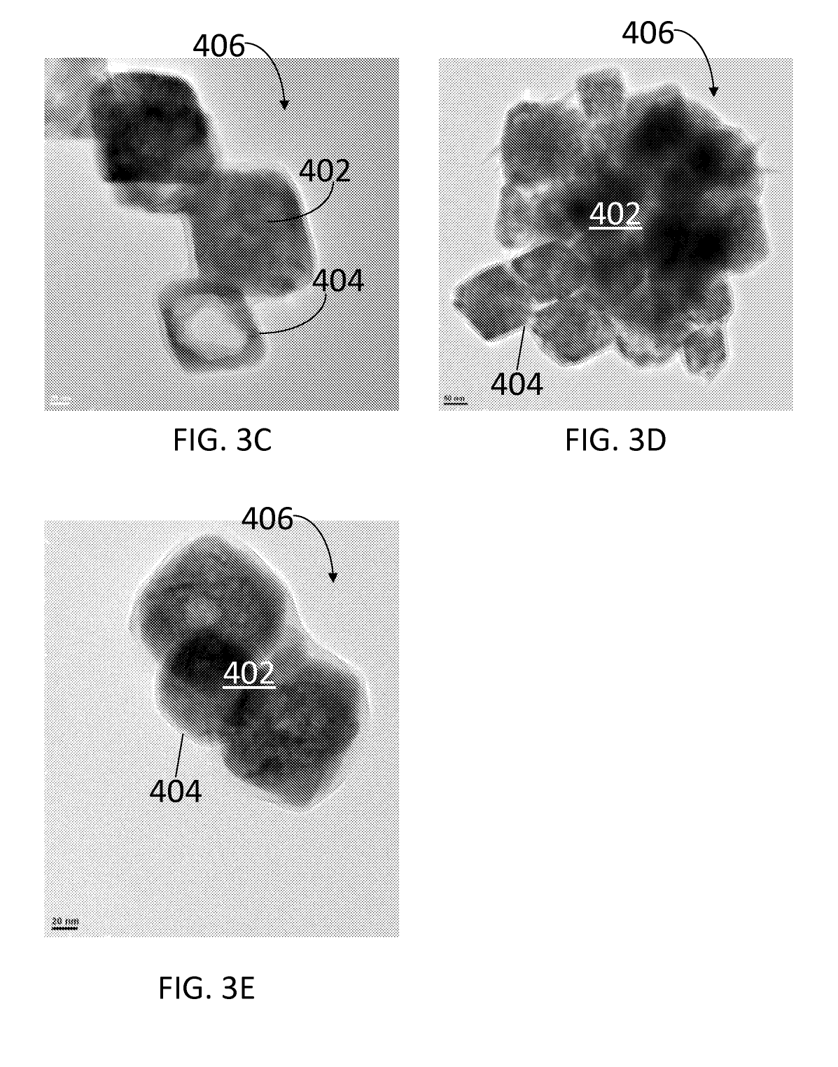

Instead of nanoparticles 106 being anchored on the metallic core 102, a particle 400 can include a shell 404 of a first metal that surrounds a core 102 of a second metal, as shown in FIG. 3A. The first metal can be different from the second metal to form a bimetallic particle, or the first metal can be the same as the second metal.

FIG. 3B shows a method 410 of forming particles 400. Particles of the metallic core are dispersed in a solvent in step 412, before a salt of the metal of the shell 404 is added in step 414. A base is added in step 416, a reducing agent is added in step 418, after stirring the mixture at room temperature for 1-2 hours, the mixture is centrifuged in step 420 to separate the solid products from the liquid in the mixture in step 418. The particles 400 are collected in step 422.

In exemplary embodiments in which a copper shell 404 is formed on a copper core particle 402, copper core particles 402 can be dispersed in ethanol into which a copper salt, ammonium hydroxide, and hydrazine-monohydrate are added. After stirring at room temperature for 1-2 hours, core-shell particles 400 can be collected. As shown, Cu particles of sizes 80-100 nm can also be coated with a copper shell. FIGS. 3C-3E show TEM images of various copper core-shell particles 406. The TEM images show a thin layer of less than 5 nm of copper shell 404 covering the core particle 402.

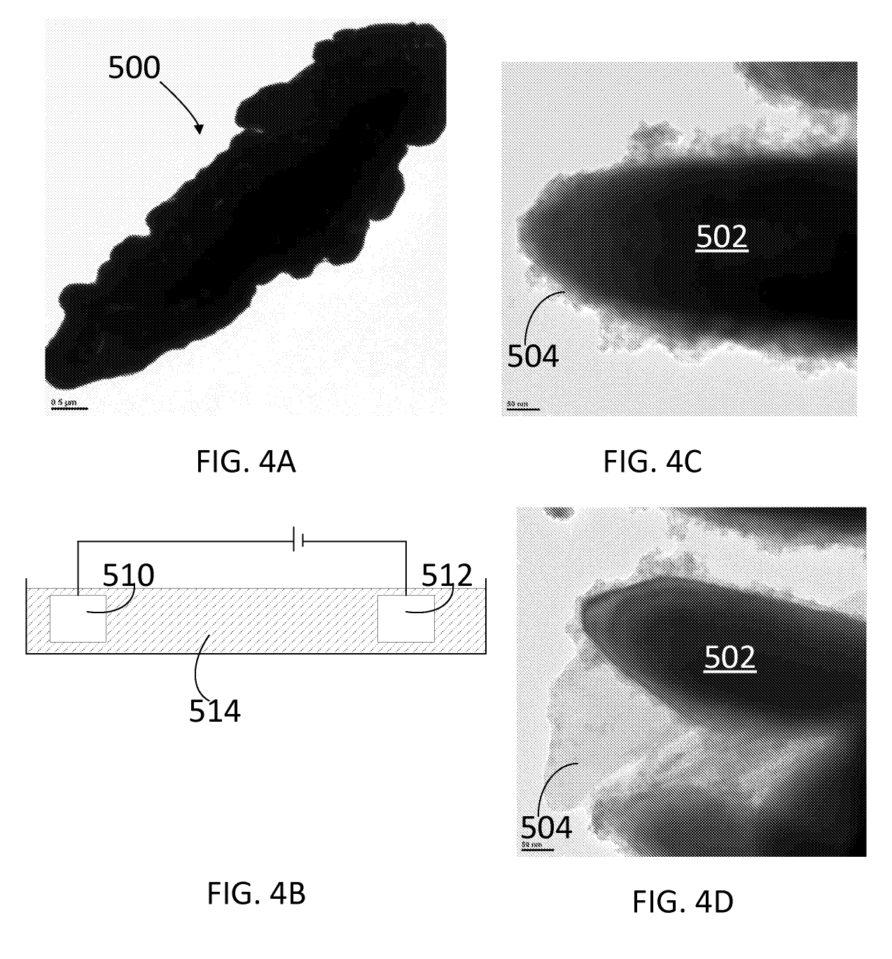

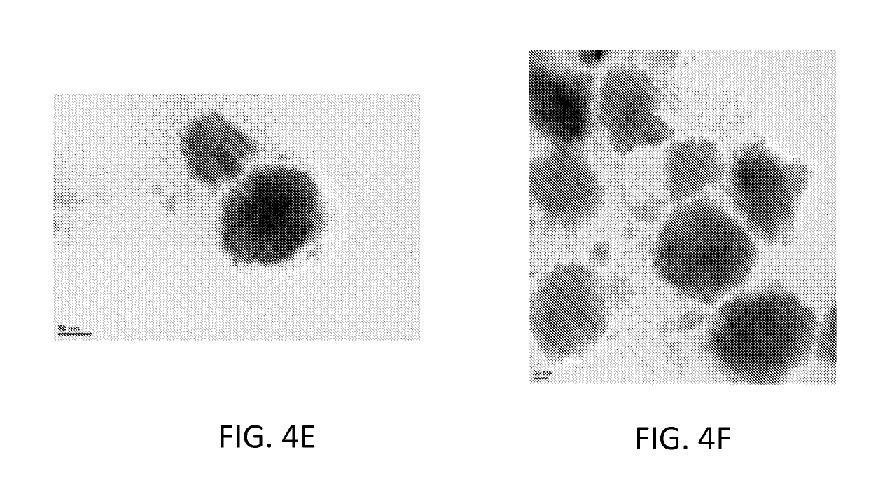

FIG. 4A shows a TEM image of an unmodified particle 500. FIGS. 4C and 4D show magnified images of a copper coating 504 deposited on a copper core particle 502 using electrochemical deposition. The copper coating 504 was deposited within a deposition time of 15 minutes, at a voltage between 0.5-9 V and a current of 1.6 A. The schematic setup of FIG. 4B shows a copper sheet 510 that is used as the anode, and a rotating barrel 512 that is used as a cathode. An electrolytic solution 514 includes 0.1 M of copper sulfate in DI water and 0.5 M of sulfuric acid. The copper deposition occurs on the cathode. As shown in FIGS. 4C and 4D, coatings occur on top of core copper particle. Uniformity of the copper coating can be controlled by optimizing electrochemical process parameters, such as deposition time, voltage, current, and precursor concentration.

FIGS. 4E and 4F show TEM images of surface modification of copper particles using electrochemical methods. The copper particles in these images are subjected for 15 minutes to 10 V and 1.72A of electricity in a 0.5 M solution of sulfuric acid. These images suggest that the copper particles appear to be breaking down under these conditions. For example, porous particles may be obtained using such a surface treatment technique.

For core particles having the same sizes, the particle 100 shown in FIG. 1A has a larger surface area than for the particle 400 shown in FIG. 4A. In some applications, it may be more desirable to have a larger surface area in the precursor material. A larger surface area helps to achieve lower sintering/melting temperature.

### EXAMPLE 1

Reactions are carried out under an inert atmosphere at room temperature, without the use of a heat source. 2-5 g of a copper salt (e.g., copper acetate monohydrate (Cu(CH₃COO)₂.H₂O), copper sulfate CuSO₄, copper hydroxide Cu(OH)₂ or other copper salts) is added to a 250 ml round bottomed flask. Less than 100 ml of ethanol and/or deionized water (DI water) is then added to dissolve the copper salt while stirring the mixture until the copper salt is dissolved completely. 2-10 ml of NH₄OH solution is added drop by drop to the copper mixture, for example, using a syringe needle. The color of the solution turns to deep blue and the mixture is stirred for a further 30 minutes at room temperature. Less than 10 ml of a reducing agent hydrazine (NH₂NH₂H₂O) is added drop by drop, using, for example, a syringe needle. Other reducing agents such as sodium borohydride, LiAlH₄ can also be used. Either strong or mild reducing agents can be used. The solution is stirred for 1-2 hrs. The product settles in the round bottomed flask after stirring has stopped. Copper nanoparticles are collected by centrifuging the mixture. The solid copper nanoparticles are washed with ethanol to remove any impurities. The copper nanoparticles are dried in a vacuum desiccator.

The copper nanoparticles are collected and stored in the vacuum desiccator for further analysis. The nanoparticles are characterized using high-resolution transmission electron microscope (HRTEM), thermogravimetric analysis (TGA), dynamic light scattering (DLS), differential scanning calorimetry (DSC). Results show Cu particles with controlled shape and sizes between 2-100 nm can be synthesized by varying the process parameters.

Briefly, the chemical reaction involves Cu(CH₃COO)₂.H₂O reacting with NH₄OH in the presence of ethanol to yield Cu(OH)₂, 2NH₄CH₃COOH and H₂O. The addition of hydrazine to these materials yields Cu, nitrogen gas and hydrogen gas.

### EXAMPLE 2

Between 1-2 g of commercial bulk Cu powder is introduced to a 100-150 ml of ethanol to form a dispersion. 2-3 ml of complexing/coordinating agent (for example, example: 1,3 propane dithiol, ethylenediamine, 1,3 diaminopropane) is added and the reaction is stirred for 2-3 hours at room temperature. 1-2 g of the Cu nanoparticles synthesized in Example 1 is added and stirred will be continued for 2-3 hour at room temperature. Solid particles settles after stirring is stopped. After centrifuging under similar conditions as those detailed in Example 1, solid Cu—Cu core-shell particles are separated from the solution and washed in absolute ethanol 2-3 times to remove any impurities. The collected solid products are dried under vacuum desiccator for 1-2 hours by connecting the desiccator to a dry vacuum pump to remove any solvent (DI water/ethanol). Results from the characterization technique (TEM/SEM) have confirmed the formation of structures depicted in FIG. 1A.

Besides attaching a second metal material on a core metal particle of a first metal, the core particle can also be or include a ceramic material. In addition, other types of materials can be attached onto the core particle. For example, covalent bonds can be formed between the core particles and the attached materials, as in the case of the attachment of a diazonium-derived aryl film on metal (e.g., gold) nanoparticles, or nanoparticles that are stabilized by metal-carbon covalent bond as the case for palladium and ruthenium nanoparticles. It is possible to chemically bind the nanomaterials together instead of simply mixing them in with the core particles. The shape of the material added to the core particle can also be optimized. For example, the added material can be a cluster having a particular shape. Organometallic complexes having multiple metal centered bridged by conjugated linkers can also be considered for use as a precursor material. Nanoparticles functionalized by acetylide derivatives through the formation of metal-acetylide conjugated dπ linkages can also be used.

The particles schematically shown in FIGS. 1A and 4A can be in the form of a powder of metallic particulates that is used as a precursor material for additive manufacturing. When the metal in the core particle is different from either the material of the shell or the material of the nanoparticles attached on the core particles, interfaces between the materials can form an alloy. In those cases, the particles are chemically heterogeneous across their diameters (or widths). An alloy of a metal in the metallic shell and a metal in the plurality of metal cores is formed at an interface of each of the plurality of metal cores and each of the metallic shell upon sintering of the metallic powder precursor during additive manufacturing. Sintering the powder precursors can include exposing the metallic powder precursor to laser radiation or electron beam bombardment.

The process throughput of additive manufacturing can be improved by first selecting a surface coverage of the metal core particles. The functionalized particles having the selected surface coverage is sintered at a particular energy and the surface quality of the sintered portion is checked. If the surface quality is not satisfy, the energy for sintering can be raised, and/or the surface coverage of the metal core particles can be adjusted (i.e., increased or decreased).

Atomic layer deposition (ALD), chemical vapor deposition (CVD), or physical vapor deposition (PVD) can also be used to coat a metal core particle. The coating can be conducted in the gas phase. Solid particles (e.g., core metallic particles) can be placed in a sample loader inside an ALD/PVD chamber and a pre-tested metal deposition process can be used to coat these core particles with a thin layer of metal used to form the shell. Some portions of the system used for the deposition process can be different from regular ALD/CVD/PVD devices.

Metal core can include one or more of refractory metals such as tungsten, molybdenum, tantalum, rhenium, transition metals such as cobalt, chromium and iron, etc., and/or noble metals such as gold, silver platinum, palladium etc.

A number of embodiments have been described. Nevertheless, it will be understood that various modifications may be made without departing from the spirit and scope of what is described.

What is claimed is:

1. A precursor for additive manufacturing, the precursor comprising:
a powder of metallic particulates, each particulate having a metal core and a functionalized surface, the metal core having a dimension a mean diameter between 200 nm and 150 μm and having a first melting temperature, the functionalized surface including a metallic material having a second melting point lower than the first melting point.

2. The metallic powder precursor of claim 1, wherein the functionalized surface comprises a plurality of metallic nanoparticles having dimensions 3-100 nm anchored on the metal core.

3. The metallic powder precursor of claim 2, wherein a metal in the plurality of metallic nanoparticles is the metal in the metal core.

4. The metallic powder precursor of claim 3, wherein the metal in the metal core consists of copper and the metal in the plurality of metallic nanoparticles consists of copper, and wherein the second melting point is lower than the first melting point.

5. The metallic powder precursor of claim 2, wherein the second melting point of the nanoparticles is at least 100° C. lower than the first melting point of the metal core.

6. The metallic powder precursor of claim 1, wherein the functionalized surface comprises a metallic shell surrounding the metal core.

7. The metallic powder precursor of claim 1, wherein the metal core comprises one or more of refractory metals, transition metals and/or noble metals.

8. The metallic powder precursor of claim 7, wherein the metallic material comprises one or more of copper, iron, nickel, titanium, tungsten, and/or molybdenum.

9. A method of synthesizing a metallic powder precursor for additive manufacturing, the method comprising:
mixing a powder of metallic microparticles with metallic nanoparticles, each metal microparticle including a metal core having a dimension between 200 nm and 150 μm, the metallic nanoparticles having a second melting temperature lower than a first melting temperature of the metal cores; and
anchoring a plurality of metallic nanoparticles on the metal core of each microparticle.

10. The method of claim 9, wherein the metallic nanoparticles are anchored onto the metal cores by a coordinating agent.

11. The method of claim 10, wherein the coordinating agent comprises at least two functional groups, one functional group forming a bond between the metal core and the coordinating agent, and at least one other functional group forming a bond between the metallic nanoparticles and the coordinating agent.

12. The method of claim 11, wherein the coordinating agent comprises a diamine, di carboxylic acid, a dithiol, an amino thiol, or a carboxy thiol.

13. A method of synthesizing metallic powder precursor for additive manufacturing, the method comprising:
providing a powder of metallic microparticles, each microparticle including a metal core that has a first melting temperature and a dimension between 200 nm and 150 μm; and
depositing a second metallic material having a second melting temperature lower than the first melting temperature on the metal core of each microparticle.

14. The method of claim 13, wherein nanoparticles of the second metallic material are deposited on each metal core.

15. The method of claim 13, wherein islands of the second metallic material are deposited on each metal core.

16. The method of claim 13, wherein a shell of the second metallic material is deposited on each metal core.

17. The method of claim 10, wherein the metal core comprises one or more of tungsten, molybdenum, aluminum, bismuth, and copper, tantalum, chromium and the shell comprises one or more of nickel, cobalt, silicon, silver, bismuth and tellurium.

18. The method of claim 10, wherein depositing the second metallic material comprises one or more of chemical reduction, physical/chemical vapor deposition, and/or electrochemical deposition.

19. A method additive manufacturing, the method comprising:
depositing on a platen a metallic powder precursor that includes a powder of metallic particulates, each particulate having a metal core and a functionalized surface, the metal core having a dimension mean diameter between 200 nm and 150 μm, the metal core having a first melting temperature, the functionalized surface including a metallic material having a second melting point lower than the first melting point; and
fusing the metallic powder precursor on the platen so that the functionalized surface melts, binds and consolidates the metallic powder precursor to form a sintered additive manufactured part.

20. The method of claim 19, wherein a rate of sintering of the metallic powder precursor is higher than a rate of sintering the metal core.

21. The method of claim 19, wherein sintering comprises exposing the metallic powder precursor to a laser or to electron beam bombardment.

22. The method of claim 21, wherein the metal core comprises one or more of refractory metals, transition metals and/or noble metals.

23. The method of claim 19, wherein the metal core comprises one or more of tungsten, molybdenum, aluminum, bismuth, and copper, and the functionalized surface comprises one or more of nickel, cobalt, silicon, silver and tellurium.
